(19) United States
(12) Patent Application Publication
(10) Pub. No.: US 2007/0218408 A1
(43) Pub. Date: Sep. 20, 2007

(54) Antipyrine Based Azo Metal Complex Dyes and Their Use in Optical Layers for Optical Data Recording

(76) Inventor: Pascal Steffanut, Kemba Loechle (FR)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/659,398

(22) PCT Filed: Aug. 5, 2005
(86) PCT No.: PCT/EP05/53861

§ 371 Date: Feb. 2, 2007

(30) Foreign Application Priority Data
Aug. 5, 2004 (EP) 04018577.9
Sep. 17, 2004 (EP) 04022251.5

(51) Int. Cl. G11B 7/246

(52) U.S. Cl. 430/270.16; 544/226; 544/225

(57) ABSTRACT

The present invention relates to antipyrine based azo metal complex dyes and their use in optical layers for optical data recording, preferably for optical data recording using a laser with a wavelength up to 450 nm. The invention further relates to a write only read many (WORM) type optical data recording medium capable of recording and reproducing information with radiation of blue laser, which employs an antipyrine based azo metal complex dye in the optical layer.

The present invention relates to antipyrine based azo metal complex dyes and their use in optical layers for optical data recording, preferably for optical data recording using a laser with a wavelength up to 450 nm.

The invention further relates to a write only read many (WORM) type optical recording medium capable of recording and reproducing information with radiation of blue laser, which employs an antipyrine based azo metal complex dye in the optical layer.

Recently, organic dyes have attracted considerable attention in the field of diode-laser optical storage. Commercial recordable compact discs (CD-R) and recordable digital versatile discs (DVD-R) can contain, as recording layer, numerous dyes based on phthalocyanine, hemicyanine, cyanine and metallized azo structures. These dyes are suitable in their respective fields with the laser wavelength criteria. Other general requirements for dye media are strong absorption, high reflectance, high recording sensitivity, low thermal conductivity as well as light and thermal stability, durability for storage or non-toxicity.

For industrial application, these dyes have to be suitable for the spin coating process to prepare thin films, i.e. they have to be sufficiently soluble in the organic solvents generally applied in the spin coating process.

WORM (write once read many) type and erasable type optical recording media reproduce information by detecting variations in the reflectivity caused by physical deformation, by alterations of optical characteristics as well as by phase and magnetic properties of a recording layer before and after the recording. Recordable compact discs (CD-R) are widely known as a WORM type optical recording medium. Recently, digital versatile discs (DVD-R) with increased information storage capabilities up to 4.7 GBytes have been commercialized. The DVD-R technology adopts as a light source a red diode laser with a wavelength of 630-670 nm. Thereby the pit size and track interval can be reduced, increasing the information storage capacity by up to 6-8 times compared to CD-R's.

Blu-ray® discs (Blu-ray® disc is a standard developed by Hitachi Ltd., LG Electronics Inc., Matsushita Electric Industrial Co. Ltd., Pioneer Corporation, Royal Philips Electronics, Samsung Electronics Co. Ltd., Sharp Corporation, Sony Corporation, Thomson Multimedia) are going to be the next milestone in optical recording technology. Its new specification increases the data storage up to 27 GBytes per recording layer for a 12 cm diameter disc. By adopting a blue diode laser with a wavelength of 405 nm (GaN or SHG laser diodes), the pit size and track interval can be further reduced, again increasing the storage capacity by an order of magnitude.

The construction of optical data recording media is known in the art. An optical data recording media generally comprises a substrate and a recording layer, the optical layer. Usually discs or wavers of organic polymeric materials are used as substrates. Preferred substrates are polycarbonate (PC) or polymethylmethacrylate (PMMA). The substrate has to provide an even and uniform surface of high optical quality. The optical layer is deposited thereon in a thin and uniform film of high optical quality and defined thickness. Finally, a reflective layer, e.g. aluminium, gold or copper, is deposited upon the optical layer.

Advanced optical data recording media may comprise further layers, such as protective layers, adhesive layers or additional optical layers.

To provide for a thin and uniform film of the optical layer, the material is usually deposited by spin coating, vacuum evaporation, jet coating, rolling coating or soaking. The preferred process in industry is spin coating to form an optical layer of about 70 nm to 250 nm thickness. For the application in the spin coating process, the material of the optical layer has to be highly soluble in organic solvents.

Antipyrazolone azo dyes of the below general formulae are known for many years (see for example DE 1076078 A and U.S. Pat. No. 2,993,884):

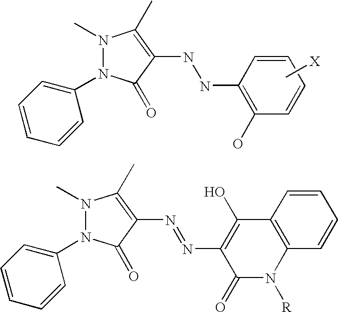

In addition to their uses as classical dyes for textiles or as dyes for copying processes, they are widely used as metallochromic indicators for spectrophotometric determination of metal contents. Extensive studies have been published on such type of complexation reactions and most of the classical aromatic diazo ligands have been investigated and described in the literature (see for example Bezdekova et al; Czech. Collection of Czechoslovak Chemical Communications, 1968, 33, 12, 4178-87 or more recently Shoukry M et al; Synthesis and reactivity in Inorganic and Metal-Organic Chemistry, 1997, 27, 5, 737-750). These azo derivatives behave generally as monobasic tridentate ligands towards metals like nickel, copper or manganese.

Antipyrine pyrazolone azo compounds are further disclosed in the following publications: Farghaly, A. M.; El-Khwass, S. M.; Khalil, M. A.; Sharabi, F. M.; Daabees, T. T Pharmazie (1981), 36(2), 93-5; Balli, H.; Ritter, H, Dyes and Pigments (1981), 2(2), 93-124; Abou-Ouf, A. A.; Abdulla, W. A.; El-Sakka, I. A. Journal of Drug Research (1975), 7(3), 1-7). They are in particular described for their medical use inter alia as antiinflamatory or analgesic agents.

Metal complexes, in particular iron (III), palladium (II) and ruthenium (III) complexes of antipyrine pyrazolone based azo compounds are described in the following publications: Azzem, M. Abdel; El-Saied, F. A.; El-Bahnasawy, R. M.; El-Sawaf, A. K.; Egyptian Journal of Chemistry (1996), 39(3), 287-293 and EL-Saied, F. A., Polish Journal of Chemistry (1995), 69(1), 14-18.

Surprisingly it has now been found, that specific antipyrine based azo metal complex dyes as described below are useful as dye compounds in optical layers for optical data recording media.

The present invention therefore relates to antipyrine based azo metal complex dyes and to their use in an optical layer comprising antipyrine based azo metal complex dyes as described below and to the use of said optical layers for optical data recording media. More particularly, the invention relates to a write only read many (WORM) type optical data recording medium capable of recording and reproducing information with radiation of blue laser of preferably 405 nm, which employs an antipyrine based azo metal complex dye in the optical layer.

The present invention is directed to the use of a dye compound of formula (I) in an optical layer for optical data recording 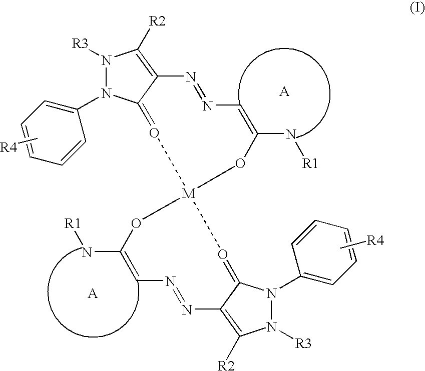
wherein
M represents a metal atom;
A is a five or six membered N-heteroaromatic cycle;
R₁ is selected from hydrogen, C₁₋₁₀ alkyl, C₅₋₁₀ cycloalkyl, the alkyl groups being optionally substituted by halogen (Cl, Br, F, I); C₁₋₁₀ alkoxy, dialkylamino, unsubstituted phenyl or substituted phenyl (with substituents being halogen, C₁₋₁₀ alkyl or nitro), unsubstituted or substituted benzyl (with substituents being halogen, C₁₋₁₀ alkyl or nitro), carboxy, C₁₋₁₀ alkyl carboxylate or NH-aryl;
R₂ is selected from hydrogen, C₁₋₁₀ alkyl, C₅₋₁₀ cycloalkyl, the alkyl groups being optionally substituted by halogen (Cl, Br, F, I); C₁₋₁₀ alkoxy, unsubstituted phenyl or substituted phenyl (with substituents being halogen, C₁₋₁₀ alkyl or nitro), unsubstituted benzyl or substituted benzyl (with substituents being halogen, C₁₋₁₀ alkyl or nitro), carboxy or C₁₋₁₀ alkyl carboxylate;
R₃ is selected from C₁₋₁₀ alkyl, C₅₋₁₀ cycloalkyl, the alkyl groups being substituted by halogen (Cl, Br, F, I) unsubstituted benzyl or substituted benzyl (with substituents being halogen, C₁₋₁₀ alkyl or nitro);
R₄ is selected from hydrogen, —Cl, —CN, —Br, —CF₃, C₁₋₄ alkyl, chloromethyl, C₁₋₄ alkoxymethyl or phenoxymethyl, NO₂ or sulfonamide.

In a preferred aspect, the present invention is directed to a dye compound of formula (I) wherein
M is selected from the group consisting of Ni, Cu, Co, Zn, Al, Fe, Pd, Pt, Cr, Mn;
A is selected to form one of the following groups 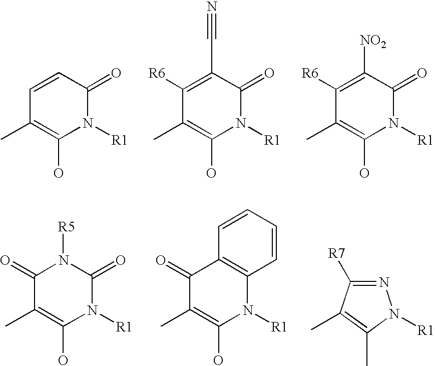
R₁ is selected from H, CH₃, C₂H₅, C₃H₇, C₄H₉, unsubstituted phenyl or substituted phenyl (with substituents being halogen, C₁₋₁₀ alkyl or nitro) or NH-aryl;
R₂ is selected from hydrogen, —CH₃, —C₂H₅, —CH(CH₃)₂, phenyl, —CN, —CF₃;
R₃ is selected from C₁₋₄ alkyl, unsubstituted benzyl or substituted benzyl (with substituents being halogen, C₁₋₁₀ alkyl or nitro);
R₄ is selected from hydrogen, —Cl, —CN, —Br, —CF₃, C₁₋₄ alkyl, chloromethyl, C₁₋₄-alkoxymethyl or phenoxymethyl, NO₂ or sulfonamide;
R₅ is selected from H, CH₃, C₂H₅, C₃H₇, C₄H₉ or phenyl;
R₆ is selected from H, CH₃, C₂H₅;
R₇ is selected from hydrogen, C₁₋₁₀ alkyl, C₅₋₁₀ cycloalkyl, the alkyl groups being optionally substituted by halogen (Cl, Br, F, I); C₁₋₁₀ alkoxy, unsubstituted phenyl or substituted phenyl (with substituents being halogen, C₁₋₁₀ alkyl or nitro), unsubstituted benzyl or substituted benzyl (with substituents being halogen, C₁₋₁₀ alkyl or nitro), carboxy or C₁₋₁₀ alkyl carboxylate;
   and to the use of said compounds in an optical layer for optical data recording.

In a more preferred aspect, the present invention is directed to a dye compound of formula (I) wherein

M is selected from the group consisting of Ni, Cu, Co, Zn, Cr;

A is selected to form one of the following groups 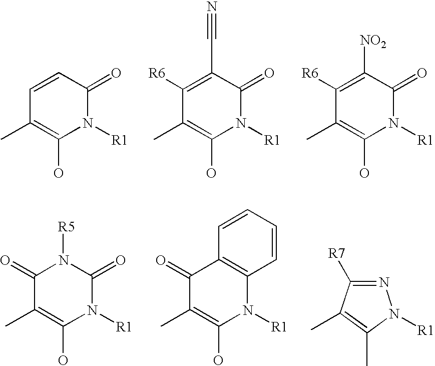
wherein
R₁ is selected from H, CH₃, C₂H₅, C₃H₇, C₄H₉ or NH-aryl;
R₂ is selected from H, CH₃, C₂H₅;
R₃ is selected from H, CH₃, C₂H₅;
R₄ is hydrogen;
R₅ is selected from H, CH₃, C₂H₅, C₃H₇, C₄H₉ or phenyl;
R₆ is selected from H, CH₃, C₂H₅;
R₇ is hydrogen, CH₃, C₂H₅;
and to the use of said compounds in an optical layer for optical data recording.

In a most preferred aspect, the present invention is directed to the use of a dye compound of formula (II), (III) or (IV) in an optical layer for optical data recording 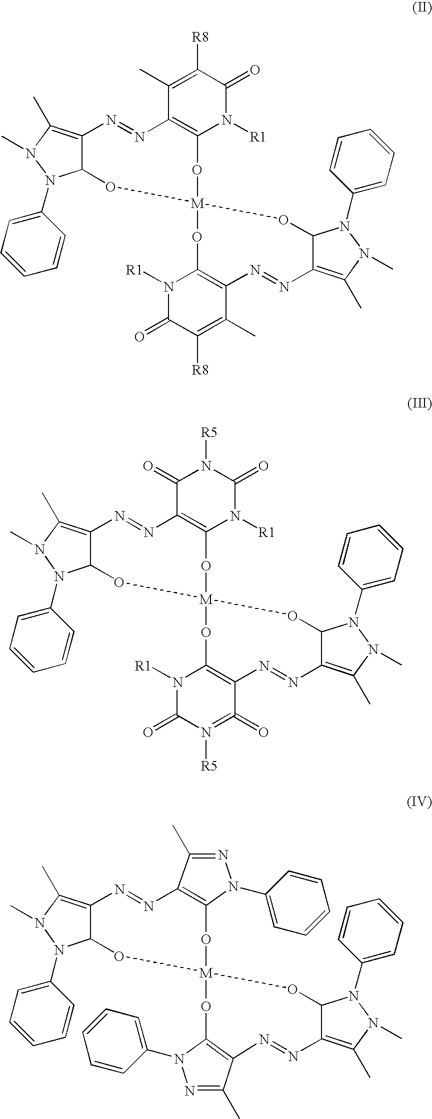
wherein
M is selected from the group consisting of Ni, Cu, Co, Zn, Cr;
R₁ is selected from CH₃, C₂H₅, C₃H₇, C₄H₉ or —NH-phenyl;
R₅ is selected from H, CH₃, C₂H₅, C₃H₇, C₄H₉ or phenyl;
R₈ is selected from —CN or NO₂.

In another most preferred aspect, the present invention is directed to a dye compound of formula (II) or (III) wherein M, R₁, R₅ and R₈ are defined as above.

The present invention further relates to an optical layer comprising a dye compound of formula (I) as described above and to the use of said optical layer for optical data recording media. An optical layer according to the invention may also comprise a mixture of two or more, preferably of two dye compounds of formula (I) as defined above.

The antipyrine based azo metal complex dye compounds of formula (I) provide for particularly preferable properties when used in optical layers for optical data recording media according to the invention.

Further, the invention relates to a method for producing optical layers comprising the following steps
(a) providing a substrate
(b) dissolving a dye compound or a mixture of dye compounds of formula (I) in an organic solvent to form a solution,
(c) coating the solution (b) on the substrate (a);
(d) evaporating the solvent to form a dye layer.

Preferred substrates are polycarbonate (PC) or polymethylmethacrylate (PMMA).

Organic solvents are selected from C₁₋₈ alcohol, halogen substituted C₁₋₈ alcohols, C₁₋₈ ketone, C₁₋₈ ether, halogen substituted C₁₋₄ alkane, or amides.

Preferred C₁₋₈ alcohols or halogen substituted C₁₋₈ alcohols are for example methanol, ethanol, isopropanol, diacetone alcohol (DAA), 2,2,3,3-tetrafluoropropanol, trichloroethanol, 2-chloroethanol, octafluoropentanol or hexafluorobutanol.

Preferred C₁₋₈ ketones are for example acetone, methylisobutylketone, methylethylketone, or 3-hydroxy-3-methyl-2-butanone.

Preferred halogen substituted C₁₋₄ alkanes are for example chloroform, dichloromethane or 1-chlorobutane.

Preferred amides are for example dimethylformamide or dimethylacetamide.

The optical layer (dye layer) obtained preferably has a thickness from 70 to 250 nm.

In a preferred aspect, the present invention provides for an optical layer suitable for high-density recording material, e.g. of the WORM disc format, in a laser wavelength range of from 350-450 nm, preferably around 405 nm.

Preparation of the Ligand

The coupling reaction may be carried out in aqueous and non-aqueous solvents. Non-aqueous solvents are alcohols such as methanol, ethanol, propanol, butanol, pentanol, etc., dipolar aprotic solvents such as DMF, DMSO, NMP and water-immiscible solvents such as toluene or chloro-benzene.

The coupling is preferably carried out in a stoichiometric ratio of coupling component and diazo component. The coupling is generally done at temperatures between −30° C. to 100° C., preference being given to temperatures of −10° C. to 30° C., and particular preference to temperatures of −5° C. to 10° C.

The coupling may be carried out in an acidic as well as an alkaline medium. Preference is given to pH <10, particular preference to pH <7.0, very particular preference to pH <5.0.

Preparation of the Metal Complexes (I)

Preferably, the complexes are prepared by reaction of a solution of one equivalent of a metal salt with a boiling solution of two equivalent of the corresponding dye. The precipitate is isolated following standard methods.

The solvents used in the process are preferably selected from the group consisting of C₁₋₈ alcohols, alkylnitriles, aromatics, dimethylformamide, N-methylpyrolidone or a mixture of one of these solvents with water or water itself.

Most preferred solvents used in the process are C₁₋₈ alcohols.

Preparation of an Optical Layer

An optical layer according to the invention comprises a metal complex of formula (I) or a mixture of metal complexes of formula (I).

A method for producing an optical layer according to the invention comprises the following steps
(a) Providing a substrate
(b) Dissolving a dye compound or a mixture of dye compounds of formula (I) in an organic solvent to form a solution,
(c) Coating the solution (b) on the substrate (a);
(d) Evaporating the solvent to form a dye layer.
   Preparing of the High Density Optical Recording Medium

A method for producing an optical recording medium comprising an optical layer according to the invention comprises the following additional steps

(e) sputtering a metal layer onto the dye layer

(f) applying a second polymer based layer to complete the disk.

A high-density data storage medium according to the invention therefore preferably is a recordable optical disc comprising: a first substrate, which is a transparent substrate with grooves, a recording layer (optical layer), which is formed on the first substrate surface using the compounds of formula (I), a reflective layer formed on the recording layer, a second substrate, which is a transparent substrate with grooves connected to the reflective layer with an attachment layer.

The optical recording medium according to the invention is preferably a recordable optical disc of the WORM type. It may be used, for example, as a playable HD-DVD (high density digital versatile disc) or Blu-ray® disc, as storage medium for a computer or as an identification and security card or for the production of diffractive optical elements, for example holograms.

The metal complexes of formula (I) in the form of a solid film have a high refractive index at the longer wavelength flank of the absorption band, which preferably achieves a peak value of from 2.0 to 3.0 in the range of from 350 to 500 nm. They further enhance the photosensitivity and the stability to light and heat compared to dyes already known in the art.

The metal complexes of formula (I) have a decomposition temperature of 250-350° C. Additionally, these compounds show an extremely good solubility in organic solvents, which is ideal for the spin-coating process to manufacture optical layers.

Thus, it is of great advantage to use these new compounds in the recording layer of high-density recordable optical discs.

### EXAMPLES

### Examples 1-5

### Dye Ligands

Diazotisation and Coupling

Ligand (1): A mixture of 20.7 g of 4-aminoantipyrine, 130 ml of water and 32 g of concentrated hydrochloric acid (30%) was gradually admixed with 24.9 ml of sodium nitrite at 0° C.; After 1 hour of reaction at 0° C., the violet-pink diazotization solution was added dropwise to an alkaline solution of 17.3 g of 1,4-dimethyl-3-cyano-6-hydroxy-pyridone while maintaining pH at 7.5-9 with sodium hydroxide (30%). The batch was stirred 3 hours then filtered with suction. The precipitate washed with water and dried. The presscake yielded 37.2 g of dye ligand of the following formula (I).

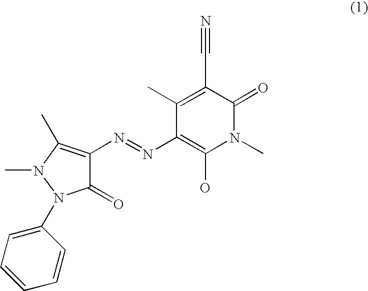

The diazotisation and coupling was repeated with other coupling components to yield dye ligands of the following formula (2)-(5).

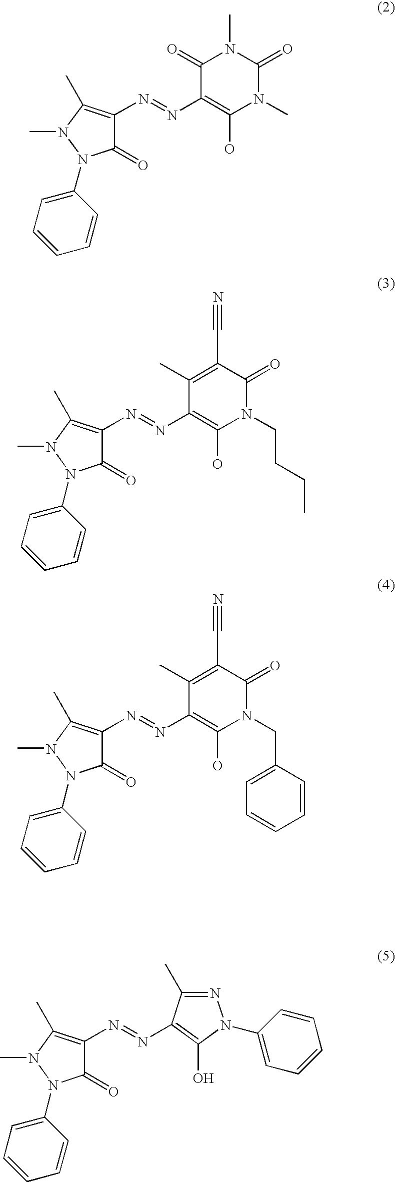

### Examples 6-13

### Metal Complexes of General Formula (I)

7.6 g of the monoazo dyestuff (1) described in example 1 are suspended in 100 ml of ethanol together with 1.7 g of sodium acetate. After heating up to reflux, 2.5 g of nickel acetate in 35 ml of water are added for over one hour, whereupon a dark orange suspension of the nickel complex results. The dyestuff solution is cooled down to room temperature and the resulting precipitate is stirred for one hour, filtered and the residue washed salt free with deionized water and dried. 7.8 g of the compound (6) with the following formula is obtained. Yield: 96.3%.

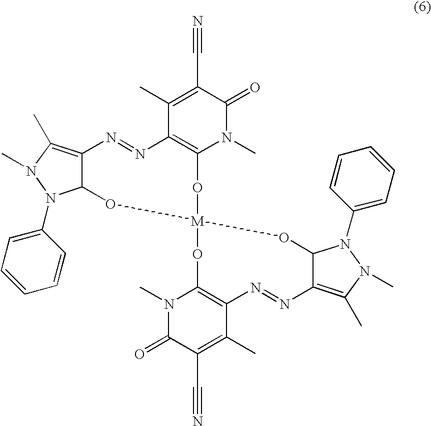

The metallisation was repeated with the other ligands of examples 2 to 5 to yield complex dye compounds of the formula (6)-(13) as given in the table below.

| Example | M | ligand | λ max | ε (λ max) | DP° C. | HR |
|---|---|---|---|---|---|---|
| 6 | Ni | 1 | 468 | 79190 | 323 | 5 |
| 7 | Cu | 1 | 462 | 78500 | 284 | 7 |
| 8 | Ni | 2 | 412 | 63800 | 334 | 12 |
| 9 | Ni | 3 | 470 | 95800 | 331 | 7 |
| 10 | Cu | 3 | 463 | 80390 | 284 | 10 |
| 11 | Ni | 4 | 467 | 91070 | 337 | 14 |
| 12 | Zn | 4 | 473 | 76150 | 326 | 24 |
| 13 | Ni | 5 | 441 | 53400 | 298 | 25 |

M: metal;
ε in l/g/cm measured at λ max;
DP: decomposition point in degree Celsius;
HR: heat release in W/g;

Application Example

The optical and thermal properties of the amino antipyrine based azo metal complex dye compounds were studied. The dyes show high absorption at the desired wavelengths. In addition, the shape of the absorption spectra, that still remains critical to the disc reflectivity and formation of clean mark edges, are composed of one major band, comprised in a range of from 350 to 500 nm.

More precisely, n values of the refractive index were evaluated between 1.0 and 2.7 (see example 1). Light stabilities were found comparable to commercial dyes which usually are stabilized with quenchers for the use in optical data recording.

Sharp threshold of thermal decomposition within the required temperature range characterizes the new amino antipyrine based azo metal complex dyes which are assumed to be desirable for the application in optical layers for optical data recording.

As a conclusion, the amino antipyrine based azo metal complex dye compounds are within the specifications which are primarily required by the industry for the use of dyes in optical data recording, in particular in the next-generation optical data recording media in the blue laser range.

1. An optical layer for optical data recording, comprising at least one dye compound of formula (I) 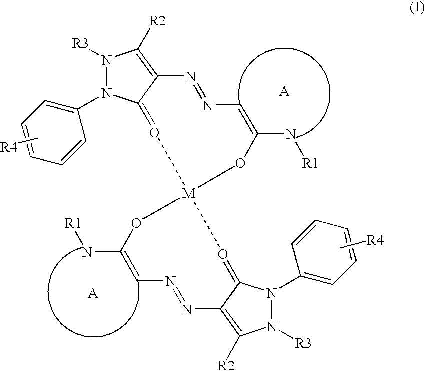
wherein
M is a metal atom;
A is a five or six membered N-heteroaromatic cycle;
R₁ is hydrogen, C₁₋₁₀ alkyl, C₅₋₁₀ cycloalkyl, the alkyl groups optionally substituted by halogen; C₁₋₁₀ alkoxy, dialkylamino, unsubstituted phenyl or substituted phenyl with substituents being halogen, C₁₋₁₀ alkyl or nitro; unsubstituted or substituted benzyl with substituents being halogen, C₁₋₁₀ alkyl or nitro; carboxy, C₁₋₁₀ alkyl carboxylate or NH-aryl;
R₂ is hydrogen, C₁₋₁₀ alkyl, C₅₋₁₀ cycloalkyl, the alkyl groups optionally substituted by halogen; C₁₋₁₀ alkoxy, unsubstituted phenyl or substituted phenyl (with substituents being halogen, C₁₋₁₀ alkyl or), nitro; unsubstituted benzyl or substituted benzyl with substituents being halogen, C₁₋₁₀ alkyl or) nitro carboxy or C₅₋₁₀ alkyl carboxylate;
R₃ is C₁₋₁₀ alkyl, C₅₋₁₀ cycloalkyl, the alkyl groups substituted by halogen; unsubstituted benzyl or substituted benzyl with substituents being halogen, C₁₋₁₀ alkyl or nitro;
R₄ is hydrogen, —Cl, —CN, —Br, —CF₃, C₁₋₄ alkyl, chloromethyl, C₁₋₄-alkoxymethyl or phenoxymethyl, NO₂ or sulfonamide.

2. The optical layer for optical data recording according to claim 1, wherein
M is selected from the group consisting of Ni, Cu, Co, Zn, Al, Fe, Pd, Pt, Cr and Mn;
A is selected to form one of the following groups 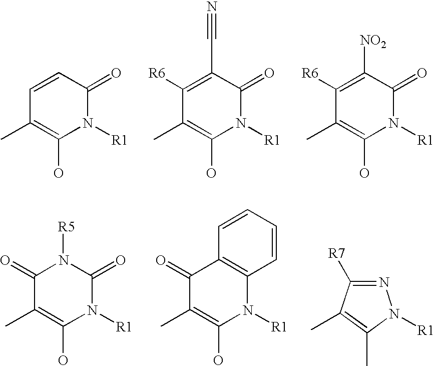
R₁ is H, CH₃, C₂H₅, C₃H₇, C₄H₉, unsubstituted phenyl or substituted phenyl with substituents being halogen, C₁₋₁₀ alkyl or nitro; or NH-aryl;
R₂ is hydrogen, —CH₃, —C₂H₅, —CH(CH₃)₂, phenyl, —CN, or —CF₃;
R₃ is C₁₋₄ alkyl, unsubstituted benzyl or substituted benzyl with substituents being halogen, C₁₋₁₀ alkyl or nitro;
R₄ is hydrogen, —Cl, —CN, —Br, —CF₃, C₁₋₄ alkyl, chloromethyl, C₁₋₄-alkoxymethyl or phenoxymethyl, NO₂ or sulfonamide;
R₅ is H, CH₃, C₂H₅, C₃H₇, C₄H₉ or phenyl;
R₆ is from H, CH₃ or C₂H₅;
R₇ is hydrogen, C₁₋₁₀ alkyl, C₅₋₁₀ cycloalkyl, the alkyl groups being optionally substituted by halogen; C₁₋₁₀ alkoxy, unsubstituted phenyl or substituted phenyl (with substituents being halogen, C₁₋₁₀ alkyl or nitro;
unsubstituted benzyl or substituted benzyl with substituents being halogen, C₁₋₁₀ alkyl or nitro; carboxy or C₁₋₁₀ alkyl carboxylate.

3. The optical layer for optical data recording according to claim 1, wherein
M is selected from the group consisting of Ni, Cu, Co, Zn and Cr;
A is selected to form one of the following groups 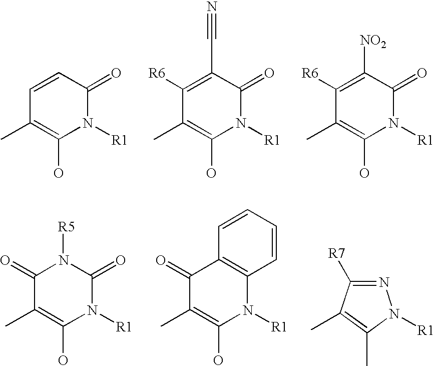
wherein
R₁ is H, CH₃, C₂H₅, C₃H₇, C₄H₉ or NH-aryl;
R₂ is H, CH₃ or C₂H₅;
R₃ is H, CH₃ or C₂H₅;
R₄ is hydrogen;
R₅ is H, CH₃, C₂H₅, C₃H₇, C₄H, or Phenyl;
R₆ is H, CH₃ or C₂H₅;
R₇ is hydrogen, CH₃ or C₂H₅.

4. The optical layer for optical data recording according to claim 1, wherein the at least one dye compound is selected from formula (II), (III) or (IV) 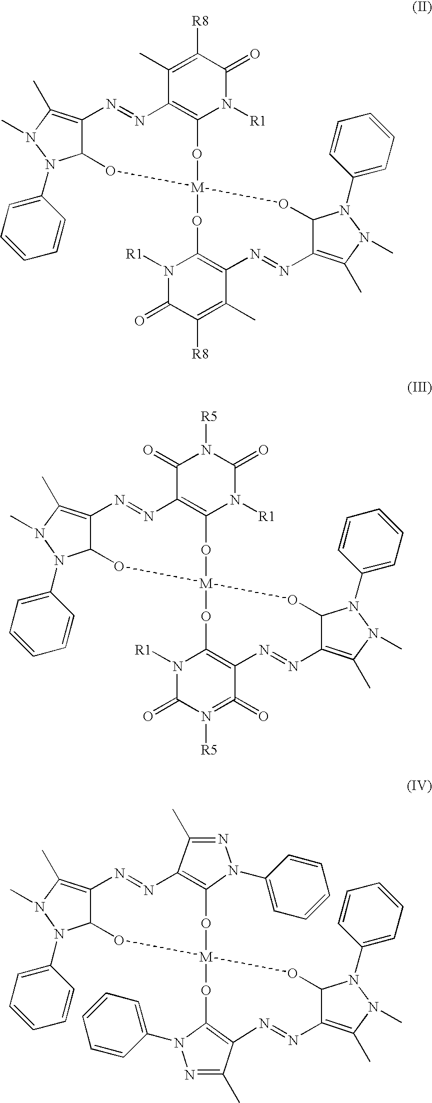
wherein
M is selected from the group consisting of Ni, Cu, Co, Zn and Cr;
R₁ is CH₃, C₂H₅, C₃H₇, C₄H₉ or —NH-phenyl;
R₅ is H, CH₃, C₂H₅, C₃H₇, C₄H₉ or phenyl;
R₈ is —CN or NO₂.

5. (canceled)

6. A method for producing an optical layer for optical data recording according to claim 1, comprising the steps of
(a) providing a substrate
(b) dissolving a dye compound or a mixture of dye compounds of formula (I), as defined in claim 1 in an organic solvent to form a solution,
(c) coating the solution (b) on the substrate (a);
(d) evaporating the solvent to form a dye layer.

7. The method according to claim 6, wherein the substrate is polycarbonate or polymethylmethacrylate.

8. A The method according to claim 6, wherein the organic solvent is selected from the group consisting of C₁₋₈ alcohol, halogen substituted C₁₋₈ alcohols, C₁₋₈ ketone, C₁₋₈ ether, halogen substituted C₁₋₄ alkane and amides.

9. An optical recording medium comprising an optical layer according to claim 1.

10. A dye compound of formula (II) or (III) 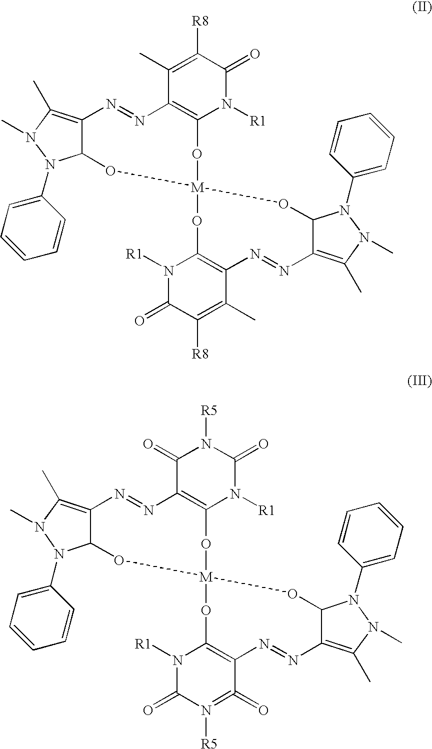
wherein
M is selected from the group consisting of Ni, Cu, Co, Zn and Cr;
R₁ is CH₃, C₂H₅, C₃H₇, C₄H₉ or —NH-phenyl;
R₅ is H, CH₃, C₂H₅, C₃H₇, C₄H₉ or phenyl;
R₈ is —CN or NO₂.

11. The optical layer for optical data recording according to claim 1, wherein in at least one of R₁, R₂ or R₃ the halogen is selected from the group consisting of Cl, Br, F and I.

12. An optical recording layer for optical data recording comprising at least one dye compound according to claim 10.

13. An optical recording medium comprising an optical layer according to claim 12.
